(19) United States
(12) Patent Application Publication
(10) Pub. No.: US 2009/0158352 A1
(43) Pub. Date: Jun. 18, 2009

(54) SYSTEM AND METHOD FOR PROVIDING PURCHASABLE ENHANCEMENTS OF VOD SERVICES

(75) Inventors: Arturo A. Rodriguez, Norcross, GA (US); Dean F. Jerding, Roswell, GA (US)

Correspondence Address: THOMAS, KAYDEN, HORSTEMEYER & RISLEY;SCIENTIFIC ATLANTA, A CISCO COMPANY, 600 GALLERIA PKWY SE, SUITE 1500, ATLANTA, GA, 30339-5994, US

(73) Assignee: Scientific-Atlanta, Inc., Lawrenceville, GA (US)

(21) Appl. No.: 12/388,002

(22) Filed: Feb. 18, 2009

Related U.S. Application Data
(62) Division of application No. 09/947,890, filed on Sep. 6, 2001.
Application No. 09/947,890 is a continuation-in-part of application No. 09/692,920, filed on Oct. 20, 2000.
Application No. 09/692,920 is a continuation-in-part of application No. 09/693,288, filed on Oct. 20, 2000.
Application No. 09/693,288 is a continuation-in-part of application No. 09/692,995, filed on Oct. 20, 2000.
Application No. 09/692,995 is a continuation-in-part of application No. 09/542,484, filed on Apr. 3, 2000.
Application No. 09/542,484 is a continuation-in-part of application No. 09/693,780, filed on Oct. 20, 2000, now Pat. No. 7,200,857.
Application No. 09/693,780 is a continuation-in-part of application No. 09/693,784, filed on Oct. 20, 2000, now Pat. No. 7,150,031.
Application No. 09/693,784 is a continuation-in-part of application No. 09/693,790, filed on Oct. 20, 2000.

(51) Int. Cl. H04N 5/445

(52) U.S. Cl. 725/58; 725/61

(57) ABSTRACT

A method for providing a television service enhancement includes receiving a first user input requesting a television service, providing the user with an option to receive an enhancement to the television service for a charge, and receiving a second user input selecting the option to receive the enhancement to the television service.

### CROSS-REFERENCE TO RELATED APPLICATION

This application is a divisional of U.S. patent application entitled, “Television Service Enhancements,” having Ser. No. 09/947,890, filed on Sep. 6, 2001, which is incorporated by reference herein in its entirety.

This application is a continuation-in-part of U.S. patent applications Ser. Nos. 09/692,920, 09/693,288, 09/692,995, 09/693,790, 09/693,784, and 09/693,780, filed on Oct. 20, 2000, and of U.S. patent application Ser. No. 09/542,484 filed on Apr. 3, 2000, all of which are hereby incorporated by reference herein in their entirety.

### FIELD OF THE INVENTION

This invention relates in general to television systems, and more particularly, to the field of subscriber television systems.

### BACKGROUND OF THE INVENTION

Cable television systems are now capable of providing many services in addition to analog broadcast video. In implementing enhanced programming, the home communication terminal (“HCT”), otherwise known as the settop box, has become an important computing device for accessing various video services. In addition to supporting traditional analog broadcast video functionality, digital HCTs (or “DHCTs”) now also support an increasing number of two-way digital services such as video-on-demand.

A DHCT is typically connected to a cable or satellite television network and includes hardware and software necessary to provide various services and functionality. Preferably, some of the software executed by a DHCT is downloaded and/or updated via the cable television network. Each DHCT also typically includes a processor, communication components and memory, and is connected to a television or other display device, such as a personal computer. While many conventional DHCTs are stand-alone devices that are externally connected to a television, a DHCT and/or its functionality may be integrated into a television or personal computer, as will be appreciated by those of ordinary skill in the art.

Services that can be provided by DHCTs include video-on-demand (VOD), and interactive program guides (IPGs), among others. VOD services allow a subscriber (hereinafter also referred to as “user”) to receive a requested movie on demand, i.e. immediately or soon after a request for the movie is placed. An IPG provides a user with a list of television programs along with the corresponding time and channel listings while allowing a user to browse through the program listings via, for example, a remote control device. One problem with conventional DHCT services is that the quality and functionality provided by each service is limited. This is a problem not only for the users who demand better quality and greater functionality, but it is also a problem for the television service providers who must strive to satisfy their customers while remaining competitive and profitable. Therefore, there is a need for providing television services that offer enhanced quality and/or functionality.

### BRIEF DESCRIPTION OF THE DRAWINGS

The invention can be better understood with reference to the following drawings. The components in the drawings are not necessarily drawn to scale, emphasis instead being placed upon clearly illustrating the principles of the present invention. In the drawings, like reference numerals designate corresponding parts throughout the several views.

FIG. 1 is a block diagram depicting a non-limiting example of a television services system.

FIG. 2 is a block diagram depicting a non-limiting example of a DHCT.

FIG. 3 is a block diagram depicting a non-limiting example of selected contents of the flash memory depicted in FIG. 2.

FIG. 4 is a block diagram depicting a non-limiting example of selected contents of the DRAM depicted in FIG. 2.

FIG. 5 is a block diagram depicting a non-limiting example of the headend depicted in FIG. 1.

FIG. 6 depicts a non-limiting example of a remote control device that is used to provide user input to the DHCT.

FIG. 7 depicts a non-limiting example of a VOD service enhancement configuration screen that may be used by a system operator to determine VOD service enhancement options that may be requested by users.

FIG. 8 depicts a non-limiting example of a VOD service enhancement configuration screen that is an alternative embodiment to the VOD service enhancement configuration screen depicted in FIG. 7.

FIG. 9 depicts a non-limiting example of a VOD rental selection screen that can be used to request a VOD presentation.

FIG. 10 depicts a non-limiting example of a personal identification number (PIN) entry screen that may be presented to the user after the user selects a video title via the VOD rental selection screen depicted in FIG. 9.

FIG. 11 is a diagram depicting an example rental period selection screen that may be presented to a user after the user enters a PIN via PIN entry screen depicted in FIG. 10.

FIG. 12 depicts a non-limiting example of a VOD service enhancement selection screen that may be provided to a user after the user selects a rental period via rental period selection screen depicted in FIG. 11.

FIG. 13 depicts a non-limiting example of a stopped video screen that is presented to the user after the user stops the playing of a VOD presentation.

FIG. 14 depicts a non-limiting example of a VOD catalog enhancement selection screen.

FIG. 15 depicts a non-limiting example IPG screen that illustrates an initial program guide arrangement in a time format.

FIG. 16 depicts a non-limiting example of an IPG enhancement selection screen which may be provided to a user after the user requests that an IPG be upgraded.

FIG. 17 is a flow chart depicting a non-limiting example of a service enhancement implementation routine that is initiated after a user requests a service enhancement.

FIG. 18 is a flow chart depicting a service enhancement implementation routine that is an alternative embodiment to the service enhancement implementation routine illustrated in FIG. 17.

### DETAILED DESCRIPTION OF THE PREFERRED EMBODIMENTS

The preferred embodiments of the present invention now will be described more fully hereinafter with reference to the accompanying drawings. This invention may, however, be embodied in many different forms and should not be construed as limited to the embodiments set forth herein.

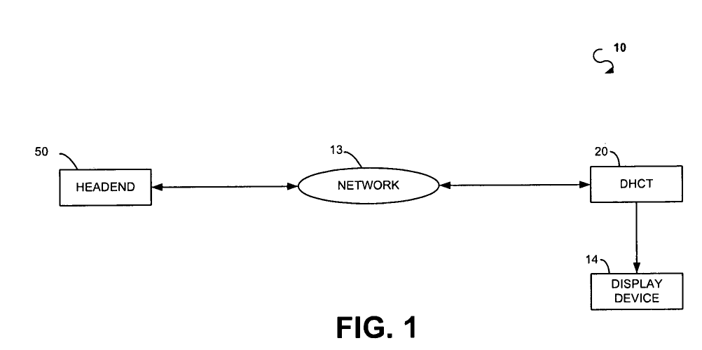

FIG. 1 is a block diagram depicting a non-limiting example of a television services system 10. In this example, the television services system 10 includes a headend 50 and a DHCT 20 that are coupled via a network 13, and a display device 14 that is coupled to the DHCT 20. The DHCT 20 is typically situated at a user's residence or place of business and may be a stand-alone unit or integrated into another device such as, for example, among others, the display device 14 or a personal computer (not shown). The DHCT 20 receives signals (video, audio and/or other data) from the headend 50 through the network 13 and provides any reverse information to the headend 50 through the network 13. The network 13 may be any suitable means for communicating television services data including, for example, among others, a cable television network, a public switched telephone network (PSTN), a satellite communication network, the internet, etc. The headend 50 includes one or more server devices (not shown) for providing video, audio, and textual data to client devices such as DHCT 20. The headend 50 and the DHCT 20 cooperate to provide a user with television services including, for example, among others, television programs, an interactive program guide (IPG), and/or video-on-demand (VOD) presentations. The television services are provided via the display device 14 which is typically a television set. However, the display device 14 may also be any other device capable of displaying video images including, for example, among others, a computer monitor.

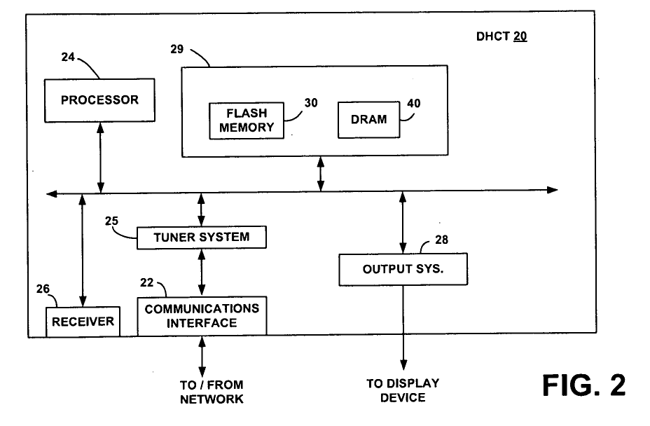

FIG. 2 is a block diagram depicting a non-limiting example of a DHCT 20. The DHCT 20 described herein is merely illustrative and should not be construed as implying any limitations upon the scope of the present invention. The DHCT 20 preferably includes a communications interface 22 for receiving signals (video, audio and/or other data) from the headend 50. The DHCT 20 further includes at least one processor 24 for controlling operations of the DHCT 20, an output system 28 for driving the display device 14, and a tuner system 25 for tuning to a particular television channel to be displayed and for sending and receiving various types of data or media to/from the headend 50. The tuner system 25 includes, in one implementation, an out-of-band tuner for bi-directional quadrature phase shift keying (QPSK) data communication and a quadrature amplitude modulation (QAM) tuner for receiving television signals. Additionally, a receiver 26 receives externally-generated user inputs or commands from an input device such as, for example, a remote control device.

In an alternative implementation, the DHCT 20 may also include one or more wireless or wired interfaces (not shown), also called ports, for receiving and/or transmitting data to other devices. For instance, the DHCT 20 may feature a USB (Universal Serial Bus), an Ethernet port (for connection to a computer), an IEEE-1394 connection (for connecting to consumer electronics equipment), a serial port, and/or a parallel port. In this manner, user inputs may, for example, be provided via a computer, via buttons or keys located on the exterior of the DHCT 20, via a hand-held remote control device, and/or via a keyboard that includes user-actuated buttons, etc.

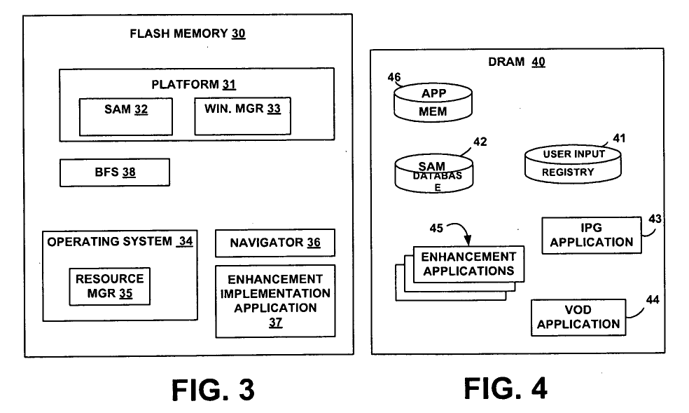

In one implementation, system memory 29 includes flash memory 30 and dynamic random access memory (DRAM) 40 for storing various applications, modules and data for execution and use by the processor 24. With continued reference to FIG. 2, FIGS. 3 and 4 are non-limiting examples of selected components stored in flash memory 30 and DRAM 40, respectively. Basic functionality of the DHCT 20 is provided by an operating system 34 that is primarily stored in flash memory 30. Among other things, the operating system 34 includes at least one resource manager 35 that provides an interface to and coordination of resources of the DHCT 20 such as, for example, computing resources.

One or more programmed software applications, herein referred to as applications, are executed by utilizing the computing resources in the DHCT 20. Applications stored in flash memory 30 or DRAM 40 are executed by processor 24 (e.g., a central processing unit or digital signal processor) under the auspices of the operating system 34. Data required as input by an application is stored in DRAM 40 or flash memory 30 and read by processor 24 as need be during the course of the application's execution. Input data may be data stored in DRAM 40 by a secondary application or other source, either internal or external to the DHCT 20, or possibly anticipated by the application and thus created with the application at the time it was generated as a software application, in which case it is stored in flash memory 30. Data generated by an application is stored in DRAM 40 by processor 24 during the course of the application's execution. DRAM 40 also includes application memory 46 that various applications may use for storing and/or retrieving data.

An application referred to as navigator 36 is also resident in flash memory 30 for providing a navigation framework for services provided by the DHCT 20. The navigator 36 registers for and in some cases reserves certain user inputs related to navigational keys such as channel increment/decrement, last channel, favorite channel, etc. The client applications may be resident in flash memory 30 or downloaded into DRAM 40. The navigator 36 also provides users with television related menu options that correspond to DHCT functions such as, for example, among others, providing an interactive program guide, blocking a channel or a group of channels from being displayed in a channel menu, and displaying a video-on-demand purchase list.

The flash memory 30 also contains a platform library 31. The platform library 31 is a collection of utilities useful to applications, such as a timer manager, a compression manager, a configuration manager, an HTML parser, a database manager, a widget toolkit, a string manager, and other utilities (not shown). These utilities are accessed by applications via application programming interfaces (APIs) as necessary so that each application does not have to contain these utilities. Two components of the platform library 31 that are shown in FIG. 3 are a window manager 33 and a service application manager client (SAM) 32.

The window manager 33 provides a mechanism for implementing the sharing of the screen regions and user input. The window manager 33 is also responsible for, as directed by one or more applications, implementing the creation, display, and allocation of the limited DHCT 20 screen resources. Window manager 33 allows multiple applications to share the screen by assigning ownership of screen regions, or windows. Window manager 33 communicates with resource manager 35 to coordinate available resources (such as display memory) among different resource-consuming processes. Such processes may be directly or indirectly invoked by one or more applications. The window manager 33 also maintains, among other things, a user input registry 41 in DRAM 40 so that when a user enters a key or a command via the remote control device 100 or another input device such as a keyboard or mouse, the user input registry 41 is accessed to determine which of various applications running on the DHCT 20 should receive data corresponding to the input key and in which order. As an application is executed, it registers a request to receive certain user input keys or commands. When the user presses a key corresponding to one of the commands on the remote control device 100, the command is received by the processor 26 and relayed to the processor 24. The processor 24 dispatches the event to the operating system 34 where it is forwarded to the window manager 33 which ultimately accesses the user input registry 41 and routes data corresponding to the incoming command to the appropriate application.

The SAM client 32 is a client component of a client-server pair of components, with the server component being located on the headend 50. A SAM database 42 in DRAM 40 includes a data structure of services, a data structure of applications, and a data structure of channels that are created and updated by the headend 50. Many television services can be defined using the same application component, with different parameters. Television services include, without limitation and in accordance with one implementation, the presentation of television broadcast programs, video-on-demand (VOD), and interactive program guides (IPG). In general, the identification of a service includes the identification of an executable application that provides the service along with a set of application-dependent parameters that indicate to the application the service to be provided. As a non-limiting example, among others, a service of presenting a television program could be provided by a WatchTV application executing on processor 24 with a set of parameters to view HBO or with a separate set of parameters to view CNN. Each association of the application component (watch TV) and one parameter component (HBO or CNN) represents a particular service that has a unique service I.D. The SAM client 32 also interfaces with the resource manager 35, as discussed below, to control resources of the DHCT 20.

Application clients, including enhancement applications 45, can also be downloaded into DRAM 40 at the request of the SAM client 32, typically in response to a request by the user or in response to a message from the headend. In this non-limiting example DRAM 40 contains a video-on-demand (VOD) application 44, an interactive program guide (IPG) application 43, and enhancement applications 45. It should be clear to one with ordinary skill in the art that these applications are not limiting and merely serve as examples for this present embodiment of the invention. Furthermore, one or more DRAM based applications may, as an alternative embodiment, be resident in flash memory 30. These applications, and others provided by the cable system operator, are top level software entities on the network for providing services to the user.

In one implementation, applications executing on the DHCT 20 work with the navigator 36 and the SAM client 32 by abiding by several guidelines. First, an application utilizes the SAM client 32 for the provision, activation, and suspension of services and service enhancements. Second, an application shares DHCT 20 resources with other applications and abides by the resource management policies of the SAM client 32, the operating system 34, and the DHCT 20. Third, an application conforms to situations where shared resources are only accessible via navigator 36. Fourth, when an application loses service authorization while providing a service, the application suspends the service via the SAM (the navigator 36 will reactivate an individual service application when it later becomes authorized). Finally, an application client is designed to not have access to certain user input keys reserved by the navigator (i.e., power, channel +/−, volume +/−, etc.).

Data and software used in providing a DHCT service to a user may be stored in one or more of the following memory resources: a data storage device located at a headend, a data storage device connected to the DHCT via a local network, a non-volatile memory internal to the DHCT, and/or a hard drive internal to the DHCT. For example, an executable program or algorithm corresponding to an operating system (OS) component, or to a client platform component, or to a client application (e.g. IPG application 43), or to respective parts thereof, may reside in and/or execute out of DRAM 40 and/or flash memory 30, or may reside in a local storage device connected to DHCT 20 and may be transferred into DRAM 40 for execution. Likewise, data input for an executable program or algorithm may reside in DRAM 40 or in flash memory 30, or may reside in a local storage device connected to the DHCT 20 and may be transferred into DRAM 40 for use by an executable program or algorithm. In addition, data output by an executable program or algorithm may be written into DRAM 40 by the executable program or algorithm and may be transferred to flash memory 30 or to a local storage device for storage purposes. It should be noted, however, that the present invention is not limited by where or how any data and/or applications are stored or retrieved.

Each of the above mentioned applications comprises executable instructions for implementing logical functions and can be embodied in any computer-readable medium for use by or in connection with an instruction execution system, apparatus, or device, such as a computer-based system, processor-containing system, or other system that can fetch and execute the instructions. In the context of this document, a “computer-readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner, and then stored in a computer memory.

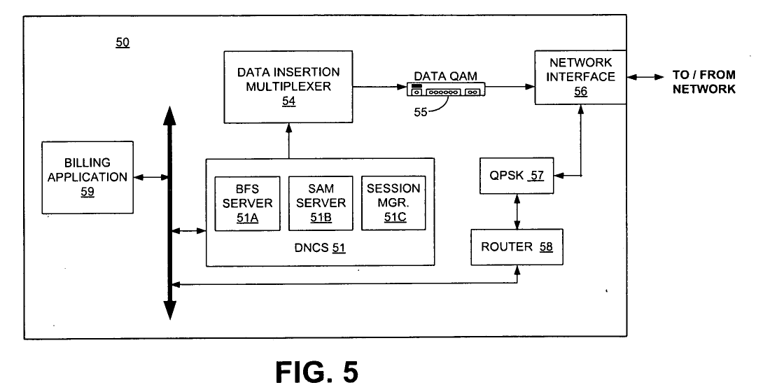

FIG. 5 depicts a non-limiting example of selected components of a headend 50 that is configured to help provide television service enhancements in accordance with one embodiment of the present invention. The DNCS 51 provides complete management, monitoring, and control of the network's elements and of the broadcast services provided to users. In one implementation, the DNCS 51 uses a data insertion multiplexer 54 and a quadrature amplitude modulation (QAM) modulator 55 to insert in-band broadcast file system (BFS) data into an MPEG-2 transport stream that is broadcast to DHCTs 20. The DNCS 51 also contains a session manager 51C that uses a Digital Storage Media Command and Control (DSMCC) protocol to set up and maintain VOD sessions. The session manager 51C processes user-to-network (U-N) session signaling messages, manages allocation of session-related network resources, supports network management operations, acts as a point of contact to the network for the DHCTs 20 in the network 13 to establish individual sessions, and supports VOD services by providing the signaling interface to establish, maintain, and release client initiated exclusive sessions.

A service application manager (SAM) server 51B is a server component of a client-server pair of components, with the client component being located at the DHCT 20. Together, the client-server SAM components provide a system in which a service is identified by the application providing the service and by a parameter that is specific to that service. The client-server SAM components also manage the life cycle of the applications on the system, including the definition, activation, and suspension of services they provide and the downloading of the applications into the DHCT 20 as necessary.

Applications on both the headend 50 and the DHCT 20 can access the data stored in a broadcast file system (BFS) server 51A in a similar manner to a file system found on operating systems. The BFS server 51A and its counterpart, a BFS client module 38 (FIG. 3), are part of a file broadcasting system. The BFS server 51A repeatedly sends data for applications on a data carousel (not shown) over a period of time in a cyclical manner so that a DHCT 20 may access the data as needed.

A QPSK modem 57 is responsible for transporting the out-of-band IP (internet protocol) datagram traffic between the distribution headend 50 and a DHCT 20. Data from the QPSK modem 57 is routed by a headend router 58. The headend router 58 is also responsible for delivering upstream application traffic to the various server applications such as, for example, a billing application 59. The billing application 59 keeps track of services and service enhancements requested by and provided to DHCT users so that the users can be charged for such services. DHCT users may be charged for a service enhancement or for a group of service enhancements in one or more ways. For example, a user may be charged based on a subscription period, usage time, frequency of use, and/or an availability period. DHCT users may also be charged for a certain service enhancement in more than one way. As a non-limiting example, among others, a user may be charged based on both usage time and frequency of use.

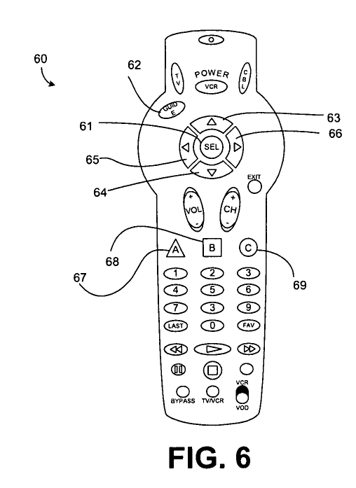

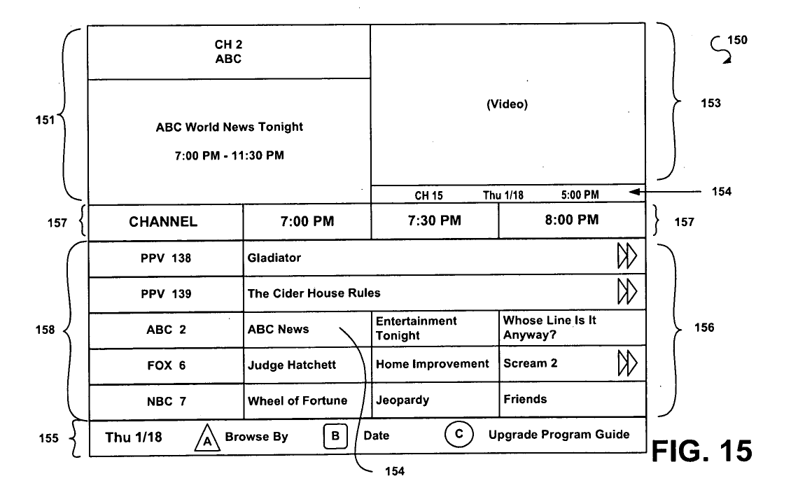

FIG. 6 depicts a non-limiting example of a remote control device 60 that is used to provide user input to the DHCT 20. Four arrow buttons are provided including an up arrow button 63, a down arrow button 64, a left arrow button 65, and a right arrow button 66. These arrow buttons 63-66 can be used to scroll through options and/or to highlight an option. The select button 61 may be used to select a currently highlighted option that is provided to the user. The guide key 62 may be used to access a television program guide such as, for example, IPG 150 (FIG. 15). The function of an A, B, or C button 67-69 varies depending on the screen being presented to a user at the time of the button's activation, and will be discussed further below. Many alternative methods of providing user input may be used including a remote control device with different buttons and/or button layouts, a keyboard device, a voice activated input system, etc. The invention described herein is not limited by the type of device used to provide user input. Furthermore, the functionality of the buttons on the remote control device described herein is merely illustrative and should not be construed as implying any limitations upon the scope of the present invention. As a non-limiting example, among others, the functionality of the arrow buttons 63-66 may be provided via a disc-shaped button (not-shown) whereby locations on the disc-shaped button correspond to respective directions on a display screen.

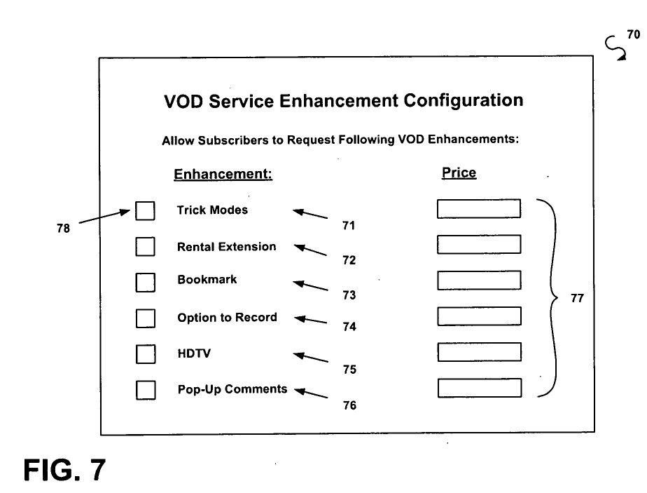

FIG. 7 depicts a non-limiting example of a VOD service enhancement configuration screen 70 that may be used by a system operator to determine VOD service enhancement options that may be requested by users. Configuration screen 70 may be generated by a VOD configuration application (not shown) that is executing at the headend 50. Similar screens may also be used to configure other types of service enhancement options. In one embodiment, among others, a distinct screen or set of screens is used to configure enhancement options for a respective type of service. In another embodiment, a first set of screens is used to configure enhancement options for a first type of service and a second set of screens is used to configure enhancement options for a plurality of service types. In yet another embodiment, a single set of screens is used to configure enhancement options for a plurality of services. Configuration screen 70 includes a list of VOD service enhancement options 71-76 and a list of price entry fields 77. In this example, the VOD service enhancement options include trick modes 71, rental extension 72, bookmark 73, option to record 74, HDTV 75, and pop-up comments 76. The trick modes option 71 can alternatively be replaced by an equivalent-meaning textual or graphical visual indication such as “random access functionality” or “VCR functionality.” The functionality provided in connections with these enhancement options 71-76 is discussed in more detail below.

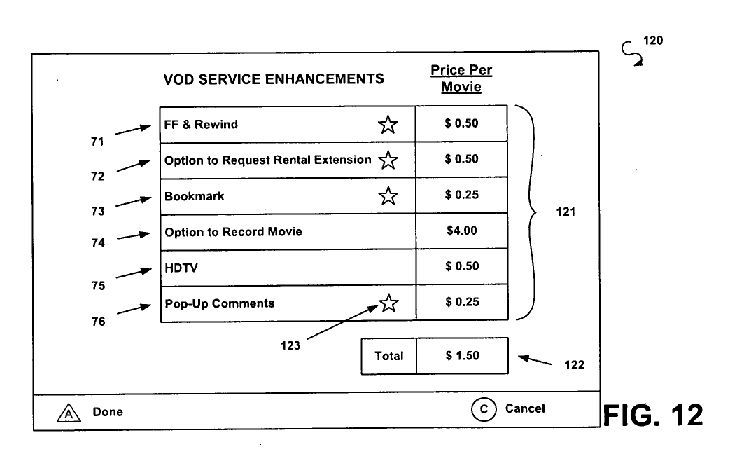

In one embodiment, among others, the system operator can determine the VOD service enhancements that users may request by selecting one or more of the service enhancement options 71-76. A system operator may make a selection via an input device such as, for example, among others, a mouse, a keyboard, or a touch-screen monitor, etc. After a service enhancement is selected by a system operator, visual feedback is provided confirming the selection. In this example such visual feedback may comprise an “X” mark displayed inside a selection box 78 located next to the selected enhancement. The system operator may also determine the prices that are to be charged for such service enhancements by entering the pricing information in the corresponding price fields 77. In an alternative embodiment, enhancement option selections and price determinations may be selected by a system operator via separate configuration screens. Enhancement options that are selected by a system operator are communicated from a headend 50 to DHCTs 20, and may be subsequently requested by a user via, for example, a VOD service enhancement selection screen 120 (FIG. 12).

It should be noted that the selections shown in configuration screen 70 are merely illustrative and that additional and/or alternative service enhancements can be implemented within the scope of the present invention. In an alternative embodiment, service enhancement options may include, for example, receiving a VOD movie having corresponding audio that is in a user selected language; such audio is commonly referred to as a second audio program or SAP. In yet another embodiment, a type of service enhancement may be offered with several levels of quality or functionality. For example, VOD service enhancement options may offer several levels of improved picture resolution and/or audio quality. Each level of quality or functionality of a service enhancement may be offered at a different price.

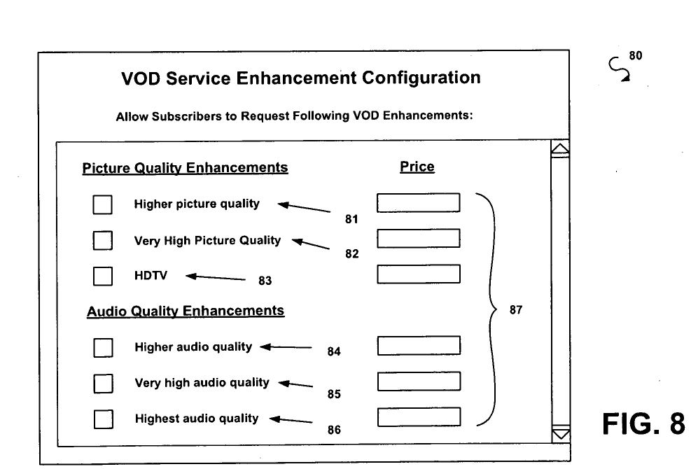

FIG. 8 depicts a non-limiting example of a VOD service enhancement configuration screen 80 that is an alternative embodiment to the VOD service enhancement configuration screen 70 (FIG. 7). Configuration screen 80 includes a list of picture quality enhancement options 81-83 and a list of audio quality enhancement options 84-86. In this non-limiting example, among others, the picture quality enhancement options include a higher picture quality option 81, a very high picture quality option 82, and an HDTV picture quality option 83; and the audio quality enhancement options include a higher audio quality option 84, a very high audio quality option 85, and a highest audio quality option 86. In one embodiment, among others, the quality of a picture or audio VOD enhancement is directly proportional to the amount of data required to encode the video or audio, respectively, of a given VOD presentation. A system operator may be presented with additional enhancement options (not shown) by scrolling down the configuration screen 80. A system operator can provide input via the configuration screen 80 to determine the enhancement options and respective prices that may be presented to a user of a DHCT 20.

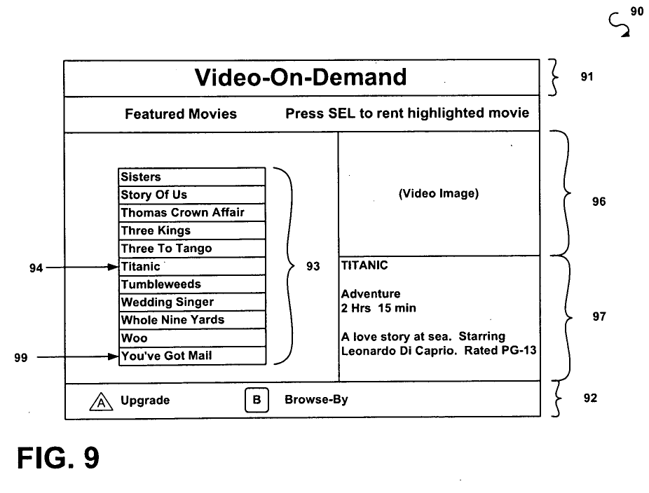

FIG. 9 depicts a non-limiting example of a VOD rental selection screen 90 that can be used by the subscriber to request a VOD presentation using the DHCT 20. The rental selection screen 90 described herein is merely illustrative and should not be construed as implying any limitations upon the scope of the present invention. Top portion 91 contains a heading, while bottom portion 92 illustrates relevant navigation buttons available on the remote control 60. In this example, bottom portion 92 suggests that the “A” button 67 may be used to request an upgrade in VOD catalog functionality while the “B” button 68 may be used to access a browse-by menu (not shown). A browse-by menu is a menu that provides the user with the option of browsing by selected categories of VOD titles such as comedy, drama, adventure, etc.

Video rental list 93 contains the titles of video presentations that are available for rent. A user may scroll through the video rental list using the up and down arrow buttons 63 & 64 on the remote control 60 and may request a currently highlighted video title by activating the select button 67. For example, a user may activate the down arrow on the remote control 60 until the selection for the movie title “You've Got Mail” 99 is highlighted, and can then request to see this presentation by activating the select button 67. A reduced screen area 96 displays an image corresponding to the currently highlighted video title. As the user scrolls through the video rental list 93, the image displayed in the reduced screen area 96 changes accordingly. Information area 97 contains information about the currently highlighted video title which, in this example, is Titanic 94. Such information may include a brief content description, a running time, and a content rating.

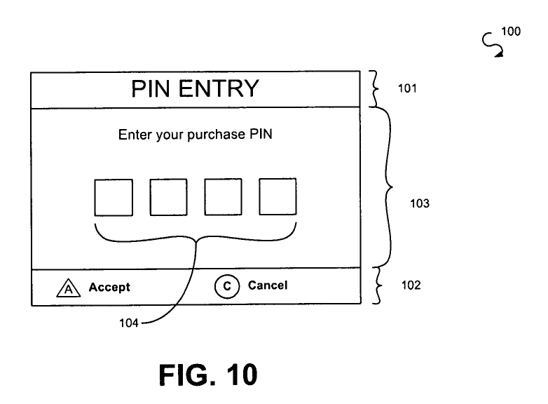

FIG. 10 depicts a non-limiting example of a personal identification number (PIN) entry screen 100 that may be presented to the user after the user selects a video title via the VOD rental selection screen 90 (FIG. 9). The top portion 101 contains the heading “PIN ENTRY” while the bottom portion 102 illustrates relevant navigation buttons available on the remote control 60. A user can enter a PIN using the remote control 60 while being presented with the PIN entry screen 100. Center portion 103 contains entry fields 104 that display a for every PIN entry received from the user. In an alternative embodiment a user is not presented with a PIN entry screen and is not required to enter a PIN. In yet another alternative embodiment, a user is only presented with a PIN entry screen under certain circumstances. Such circumstances may include, for example, if the selected video rental corresponds to a category of video rentals that has been blocked (e.g. for parental control purposes), if the cost of the video rental exceeds a pre-determined threshold, or if the user has pre-configured DHCT settings to require PIN entry.

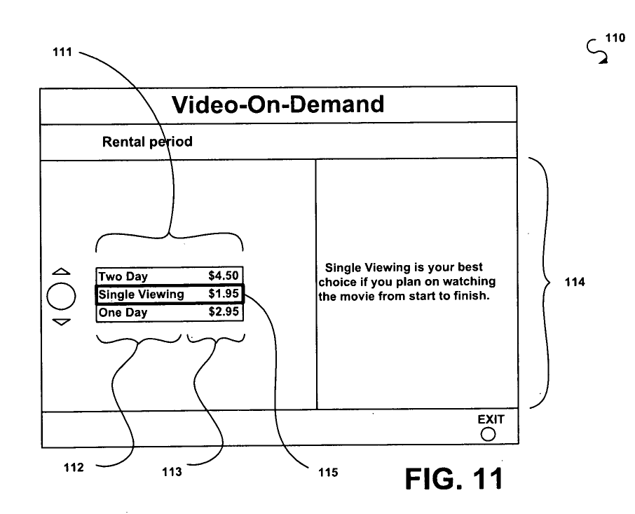

FIG. 11 is a diagram depicting an example rental period selection screen 110 that may be presented to a user after the user enters a PIN via PIN entry screen 100 (FIG. 10). In an alternative embodiment, rental period selection screen 110 can be presented to a user after the user selects a video presentation that the user wishes to rent. In yet another embodiment, rental periods are pre-determined and the user is therefore not presented with a rental period selection screen. Rental period selection screen 110 contains a rental period list 111 which includes rental periods 112 and corresponding rental prices 113. Rental period information section 114 provides information about the currently highlighted rental period which, in this example, is “single viewing” 115. A user may activate the up and down arrow buttons 63 and 64 (FIG. 6) to highlight an option and may then select the highlighted option by activating the select button 67.

FIG. 12 depicts a non-limiting example of a VOD service enhancement selection screen 120. Selection screen 120 can be provided to a user after the user selects a rental period via rental period selection screen 110 (FIG. 11). In this example, selection screen 120 includes service enhancement options 71-76; option 71 is for receiving trick mode functionality such as fast-forward or fast-rewind; option 72 is for receiving an option to request an extension to a VOD rental period some time after a VOD presentation has been requested but before the VOD rental period expires; option 73 is for receiving functionality enabling a user to bookmark a scene in a VOD presentation so that the user may later easily view the bookmarked scene; option 74 provides the user with the ability to record the requested VOD presentation; option 75 provides the user with a VOD presentation having a high level of resolution; option 76 provides the user with the ability to activate on-screen text supplements such as, for example, actor comments, director comments, critic comments, and/or viewer comments. Data identifying these options 71-76 may be stored in application memory 46 (FIG. 4) and may be retrieved by processor 24 (FIG. 2) during the execution of VOD application 44 (FIG. 4) in order to present VOD service enhancement selection screen 120. As discussed above, these options are merely examples; in an alternative embodiment, a user may be presented with different and/or additional service enhancement options as determined and configured by a system operator.

A user may select a desired service enhancement via an input device such as, for example, remote control 60. The user is also provided with price listings 121 that correspond to respective service enhancement options 71-76. After the user selects an option, a total price field 122 is updated to reflect the total price of all the active selections made by the user. Visual feedback identifying active selections is provided to the user. Such feedback may be in the form of a star icon 123 that is displayed next to each option selected by the user or via a different background or foreground color or a different intensity level for each option selected by the user. Alternatively, star icon 123 is not employed for selected options but is instead used to represent the respective enhancements that the user had previously purchased. A VOD session for the previously selected VOD presentation is implemented after the user confirms the service enhancement selections. In this example, the user may confirm the selections by activating the “A” button 67 on the remote control 60 (FIG. 6).

In one embodiment, among others, after the user confirms the selection of one or more service enhancement options, the user is presented with a screen or barker (not shown) prompting the user to provide input indicating whether the user's selections should be implemented for future VOD rentals requested by the user. If the user provides user input responding in the affirmative, then information about the selected service enhancement options is stored in non-volatile memory (not shown) at the DHCT 20 and/or at the headend 50 for future reference. This information can be used to implement the selected service enhancement options the next time that the user requests a VOD rental or to display the star icon 123 next to the respective options the user purchased the last time the user employed the service.

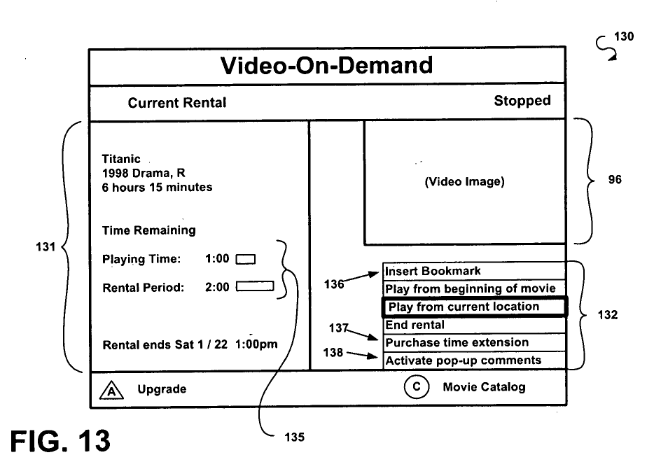

FIG. 13 depicts a non-limiting example of a stopped video screen 130 that is presented to the user after the user stops the playing of a VOD presentation. The user can stop the playing of a VOD presentation by, for example, activating a stop button on the remote control 60. A reduced screen area 96 displays an image from the VOD presentation. The displayed image is preferably the image that was being displayed immediately prior to the halt of the VOD presentation. Information section 131 contains information related to the VOD presentation, including numerical and graphical indications 135 as to the playing time and rental time remaining for the media rental.

Rental control options list 132 includes, among others, options 136-138 corresponding to service enhancement options selected via service enhancement selection screen 120 (FIG. 12). Options 136-138 may be respectively used to insert a bookmark, to purchase a VOD rental time extension, and to activate pop-up comments. Examples of the functionality that may be provided by these options 136-138 are described in the following patent applications, respectively, which are hereby fully incorporated herein by reference: U.S. patent application Ser. No. 09/692,995 filed on Oct. 19, 2000 and titled “Media-On-Demand Bookmark System,” U.S. patent application Ser. No. 09/693,288 filed on Oct. 19, 2000 and titled “Media-On-Demand Rental Duration Management System,” U.S. patent application Ser. No. 09/693,780 filed on Oct. 19, 2000 and titled “Synchronized Video-On-Demand Supplements.”

The selection of a rental control option can result in the presentation of a second menu of additional options (not shown) related to the selected option. It should be noted that certain service enhancements such as, for example, VCR functionality, can be implemented during the playing of a VOD presentation in response to receiving user input requesting such implementation. Other service enhancements such as, for example, HDTV, may be implemented throughout a VOD presentation. In one embodiment, among others, a service enhancement may be implemented in response to receiving requisite user during the playing of a VOD presentation, and/or while the VOD presentation is stopped.

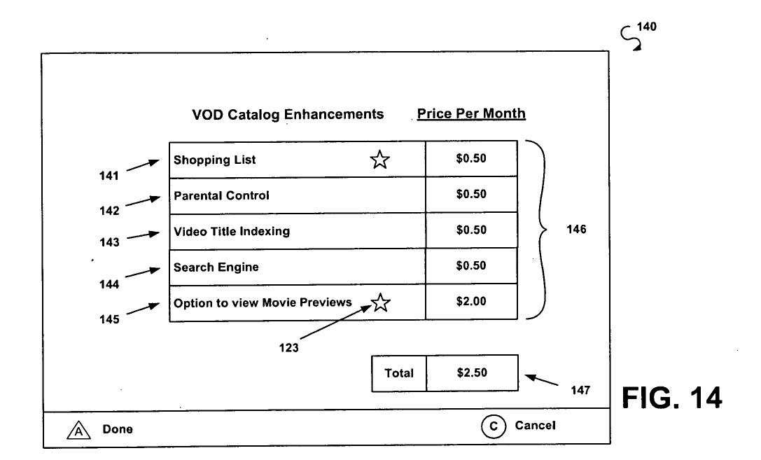

FIG. 14 depicts a non-limiting example of a VOD catalog enhancement selection screen 140. Selection screen 140 may be provided to a user after the user requests that a VOD catalog service be upgraded. A user may make such a request by, for example, activating the “A” button 67 while being presented with the VOD rental selection screen 90 (FIG. 9). In this example, selection screen 140 includes catalog enhancement options 141-145; option 141 may be used to enable the user to create a list of desired VOD titles so that the user may be reminded of these titles at a later time; option 142 may be used to enable a user to block certain channels or programs from being presented to unauthorized viewers (e.g. children); option 143 enables the user to browse sub-categories of VOD titles corresponding to a user selected indexing parameter such as an alphanumeric character or a calendar year; option 144 enables the user to search for a particular program or movie using a search engine; and option 145 enables the user to receive user-selected VOD previews. Data identifying these options 141-145 may be stored in application memory 46 (FIG. 4) and may be retrieved by processor 24 (FIG. 2) during the execution of VOD application 44 (FIG. 4) in order to present VOD catalog enhancement selection screen 140.

Examples of the functionality that may be provided pursuant to options 141-144 are described in the following patent applications, respectively, which are hereby fully incorporated herein by reference: U.S. patent application Ser. No. 09/693,784 filed on Oct. 19, 2000 and titled “Media-On-Demand Filing And Reminder System,” U.S. patent application Ser. No. 09/590,488 filed on Jun. 9, 2000 and titled “User Interface Navigational System With Parental Control For Video On Demand System,” U.S. patent application Ser. No. 09/692,920 filed on Oct. 19, 2000 and titled “Media On Demand Title Indexing System,” and U.S. patent application Ser. No. 09/693,790 filed on Oct. 19, 2000 and titled “Integrated Searching System For Interactive Media Guide.”

A user may select a desired catalog enhancement via an input device such as, for example, a remote control. The user is also provided with price listings 146 for the catalog enhancement options 141-145. After the user selects an option, the total price field 147 is updated to reflect the total price of all the selections made by the user. Visual feedback identifying active selections is provided to the user. As described above, such feedback may be in the form of a star icon 123 that is displayed next to each option selected by the user or by a different background or foreground color or a different intensity level for each option selected by the user. The selected VOD catalog enhancements are set-up and/or authorized after the user provides user input confirming the selections. In this example, the user may confirm the selections by activating the “A” button 67 on the remote control 60 (FIG. 6).

It should be noted that the catalog enhancement options 141-145 are merely illustrative and that additional and/or alternative catalog enhancement options may be requested within the scope of the present invention. As a non-limiting example, in one embodiment, among others, catalog enhancement options may include an option for receiving VOD rental recommendations based on the user's profile or ordering history.

FIG. 15 depicts a non-limiting example IPG screen 150 that illustrates an initial program guide arrangement in a time format that the DHCT 20 presents to the user in response to user input, such as, for example, the activation of the guide key 111 (FIG. 6). The top left portion of IPG screen 150 is a detailed focus area 151 that includes detailed channel information (channel number, channel name (ABC®), program name, program description, duration, any episode information or rating, etc.) for a program displayed in the highlighted program area 152 in a main program display area 156. Video showing on the channel to which the DHCT 20 is currently tuned (for which audio is also playing, and which is typically the program occupying the full screen before the user is presented with IPG screen 150) is displayed in a video area 153 in the IPG screen 150. Immediately below the video area 153 is an information banner 154 depicting the channel to which the DHCT 20 is currently tuned, the current day and date, and the current time. The main program display area 156 contains television program titles corresponding to television programs that are or will be available for viewing during the time periods listed under the time area 157 and that correspond to respective television channels identified in channel area 158. The highlighted program area 152 is centered in the main program display area 156 enabling the subscriber to scroll up and down to the various program titles listed in the main program display area 156.

The main program display area 156 includes program names organized in a grid of rows of channels and columns of time. The channel area 158 includes a vertical list of channels organized sequentially from top to bottom by increasing channel number. The main program display area 156 can be scrolled in both time and channel number dimensions. As the subscriber scrolls in time across a calendar day boundary, the selected day displayed in various areas is automatically updated.

When the IPG application is first activated by the subscriber, the first, or lowest, channel, including channel name and number, in the channel lineup is centered in the channel area 158. In this non-limiting example, among others, the lowest channel in this channel list displayed in the channel area 158 is ABC®, which is shown as channel 2. Continuing with this non-limiting example, the left-most time column in the main program display area 156 is set to include titles of programs scheduled to be broadcast about two hours into the future with the middle title being highlighted and corresponding to a program on the lowest channel. Therefore, in this example, the program ABC News which is on channel 2, is centered in the highlighted program area 152. It should be noted that the current program shown in video area 153 and referenced in information banner 154, corresponds to a currently tuned channel, which in this example is channel 13, and not to the highlighted program on channel 2. The bottom area 155 of IPG screen 150 indicates the selected day for which program data is being displayed as well as information about the current functions of the “A”, “B”, and “C” buttons 67-69 on the remote control 60 (FIG. 6). In this example, the A button 67 can be used to access a browse-by list for requesting an IPG screen that contains a subset of television programs falling under a user selected browse-by category such as, for example, among others, comedy, drama, action/adventure, sports, etc.; the B button 68 can be used to request an IPG screen containing program listings for a user selected date; and the C button 69 can be used to request an screen containing upgrade options for IPG services.

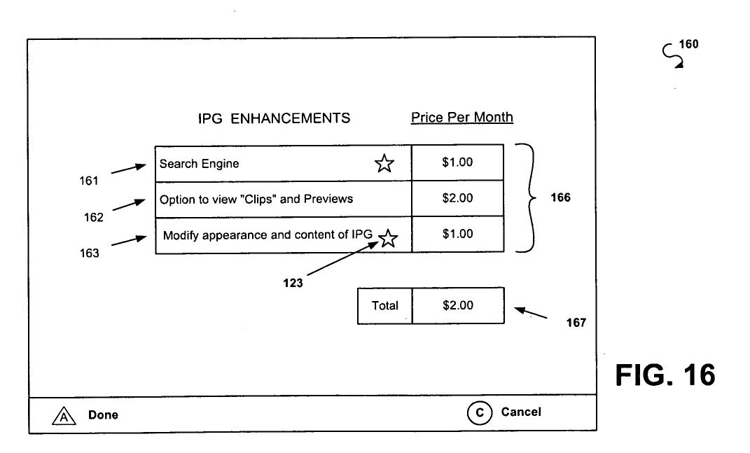

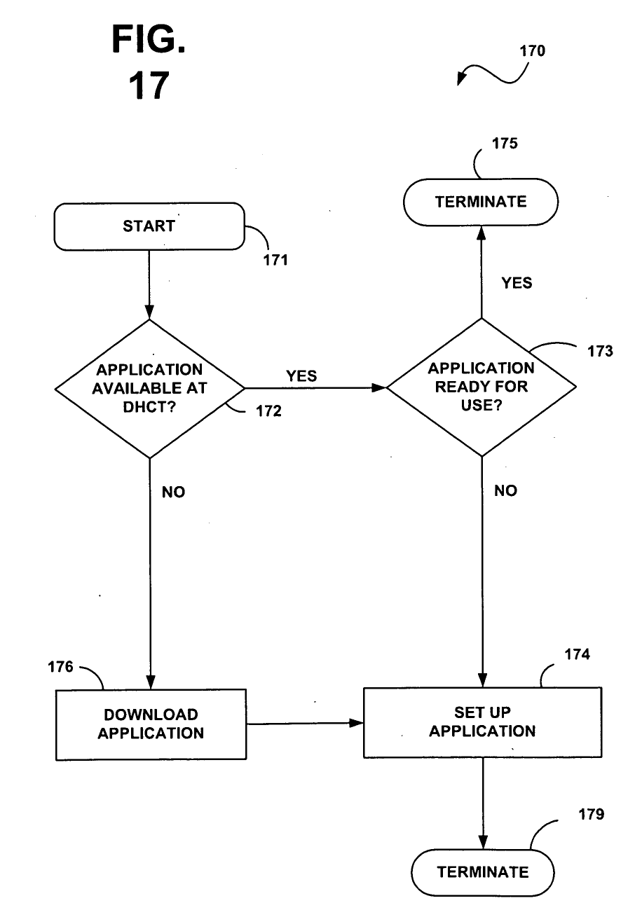

FIG. 16 depicts a non-limiting example of an IPG enhancement selection screen 160 which may be provided to a user after the user requests that an IPG be upgraded. A user may request that an IPG be upgraded by, for example, activating the “C” button 69 while being presented with IPG screen 150 (FIG. 15). In this example, IPG screen 160 includes IPG enhancement options 161-163; option 161 enables the user to search for a program using a search engine; option 162 enables the user to view clips or previews of a user-selected program; and option 163 enables the user to modify the layout and content on an IPG. Data identifying these options 161-163 may be stored in application memory 46 (FIG. 4) and may be retrieved by processor 24 (FIG. 2) during the execution of IPG application 43 (FIG. 4) in order to present IPG enhancement selection screen 160.

A user may select a desired IPG enhancement via an input device such as, for example, a remote control. The user is also provided with price listings 166 for the IPG enhancement options 161-163. Options 161-163 may be used to request service enhancements that provide the following respective functionality: a search engine for searching through IPG program listings, clips and previews of programs listed in an IPG, and tools for configuring the appearance and content of an IPG. After the user selects an option, the total price field 167 is updated to reflect the total price of currently active selections. Visual feedback identifying active selections is provided to the user. Such feedback may be in the form of a star icon 123 that is displayed next to each option selected by the user or, as described above, may be via a different background or foreground color or a different intensity level for each option selected by the user. The selected IPG enhancements are set-up and/or authorized after the user provides input confirming the selections. In this example, the user may confirm the selections by activating the “A” button 67 on the remote control 60 (FIG. 6). The user can purchase an IPG option for the display format of the IPG and/or for the first information and format displayed in the organized grid each time the user invokes the IPG application from a non-visual displayed state. The user can purchase the enhancement option for the displayed IPG grid to include the current active time interval, inclusive of the channel currently tuned or tuned immediately prior to invoking the IPG application, such that the highlighted program in the IPG grid corresponds to the current time program on the current tuned channel. It should be noted that the IPG enhancement options 161-163 are merely illustrative and that additional and/or alternative IPG enhancement options may be requested within the scope of the present invention. As a non-limiting example, in one embodiment, among others, IPG enhancement options may include an option for enabling a user to view more detailed information about programs listed in an IPG. The service enhancements described in this invention are provided by service enhancement applications, also called “child applications.” The application providing the service being enhanced is called the “parent application.” As is evident from the preferred embodiments of the VOD and IPG service, a parent application providing a service can be enhanced by one or more child applications. Alternatively, a child application can be compatible with one or more parent applications.

A service enhancement application and a parent application comply to a pre-specified design specification that defines the interfaces (APIs) in which the parent and child applications communicate, including communication of existence via the SAM client 32, functional capabilities, and exchange of input and output data that fulfill the overall enhanced functionality extended by the operation of parent and child applications working in concert. According to the supported set of functionality that is common between a parent application's capabilities and a child application's capabilities, the respective set of APIs for the common set of functional capabilities is employed for the communication between the parent and child applications.

When the service enhancement application is installed on the system, it registers with the SAM server 51B at the headend and indicates the applications with which it is compatible. Applications are identified in the SAM database by a Universal Resource Identifier (URI) In one embodiment, among others, or a numeric application ID in another. Additionally, the compatibility of parent and child applications is specified using a compatibility identifier.

A first part of an application compatibility identifier is a sub-identification that specifies a compatibility group. The compatibility group sub-identification exists in both parent and children applications. The compatibility group consists of a plurality of fields. In one embodiment, among others, a compatibility group consists of one or more 32-bit words, each 32-bit word consisting of pre-assigned demarcations or fields specifying compatibility information to a respective service enhancement category. For instance, a 32-bit word may specify eight 6-bit nibbles, each assigned to a functionality category for service enhancement. Each nibble specifies a dedicated compatibility subgroup. A first nibble is assigned to a subgroup category called “search functionality.” A second nibble is assigned as subgroup category “VOD extensions” and a third to “EPG extensions.”

Of the sixteen possible combinations of binary values for a nibble in a subgroup category, one value, e.g., 0000, denotes that the application is not compatible to the respective service enhancement category. A second value, e.g., 1111, denotes that the application is compatible to all service enhancements in this subcategory. A third value between 0000 and 1111 denotes compatibility to a first specific set of reduced functionality and a fourth value between 0000 and 1111 denotes compatibility to a second specific set of reduced functionality. A fifth value between 0000 and 1111 denotes compatibility to at least two specific sets of reduced functionality for that subcategory.

A second part of the application's compatibility identifier is a sub-identification that specifies whether the application is a child or a parent or both.

An alternative mechanism for specification of compatibility uses a compatibility list rather than a compatibility identifier. When the child application registers with the SAM it specifies the parent applications with which it is compatible in the form of a list of their application identifiers. If the child application is compatible with any number of parent applications, it so indicates by providing no applications in its compatibility list when it registers with the SAM server 51B. That is, an empty application compatibility list indicates compatibility with all parent applications (as long as the parent application abides by the API of the child application).

Non-limiting examples of service enhancement applications that provide service-specific enhancements include VOD trick modes (FIG. 7, FIG. 12) or the option to start the IPG with program information for the current time, and the currently tuned channel. These child applications are tightly coupled with their parent applications, and the Application Programming Interface (API) of each application is known to the other application at development time, as mentioned above. In this manner, it is possible for the child application to access information and functionality specific to the parent, and for the parent application to expect a particular API to be offered by the child application.

In the example of VOD trick modes, the child application provides an interface for fast-forward, rewind, etc. Upon playback of a VOD movie, the VOD application activates the VOD trick mode service enhancement application if the user purchased the enhancement. The VOD application is already programmed to display and allow the options of fast-forward, rewind etc. if the user purchased VOD trick modes. When the user selects one of the trick modes, the VOD application invokes the corresponding API in the VOD trick mode enhancement application. The VOD trick mode application can then communicate with the VOD application and the video pump at the server to fast-forward or rewind the movie, because it has been implemented with a knowledge of and has access to the VOD and video pump API. For example, the API to fast-forward the movie that is invoked by the VOD application provides the VOD trick mode application with the IP address of the video server and an identifier of the stream providing the movie.

According to the compatibility specification of each application, non-limiting examples of service enhancement applications that can enhance more than one type of service, i.e. work with multiple parent applications, include a search engine as mentioned with VOD and IPG (FIG. 14, FIG. 16), video quality selection such as HDTV (FIG. 8, FIG. 12), bookmarking (FIG. 7, FIG. 12), and pop-up comments (FIG. 7, FIG. 12). Such child applications provide a generic interface (API) that can be queried and discovered at run-time. In this way new service enhancements can be added to parent application already deployed in the system.

When a new, generic service enhancement application is installed in the system it is assigned an application identifier (URI) by the SAM server 51B. The new application sends a message to other application server components on the system via the SAM indicating the following:

1) the application URI

2) the fact that it is a generic service enhancement application

3) a textual description of the enhancement suitable for display in the parent application server configuration screen

4) the price (as configured by the system operator with the enhancement application configuration screen, not shown)

The system operator can then use parent application configuration screens such as FIG. 7 to add the enhancement to the list of enhancements available with each individual parent application, or even all parent applications.

In the example of the pop-up comments enhancement, upon being purchased by the user it is activated when the DHCT 20 boots. It registers with the operating system for notification of video tuning events. Whenever a video/audio stream is tuned, be it by a watching TV application, a VOD application, or a music application, the pop-up comments application is notified. It then queries the operating system to determine if the pop-up comments are provided along with the video and audio, as for example a private data stream in MPEG content. The pop-up comment application is programmed to be aware of various standards and delivery method of the supplemental text. If the supplemental comment data is available, the pop-up comments are displayed on the screen of the DHCT 20. All of this takes place without requiring any intervention or input from the parent application(s) that are being enhanced with the pop-up comments.

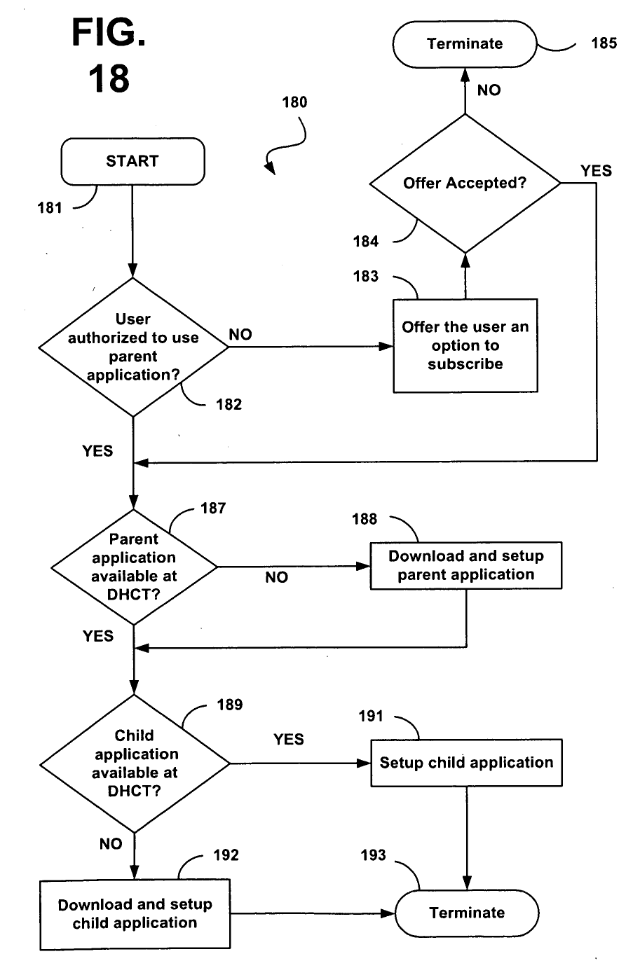

FIG. 17 is a flow chart depicting a non-limiting example of a service enhancement implementation routine 170 implemented by the SAM client 32 that is initiated after a user requests a service enhancement. A service enhancement can be requested, for example, among others, via the user interface screens depicted in FIGS. 12, 14, and 16. After the routine 170 is initiated, the routine determines in block 172 if the application corresponding to the requested service enhancement is available at the DHCT 20. If such application is available at the DHCT 20, then the routine determines in block 173 if the application is ready for use.

An application may not be ready for use if, for example, it is not loaded into a fast-access memory or it has not been initialized. If the routine determines that the application is ready for use, then the routine terminates as indicated in block 175. If, however, the routine determines that the application is not ready for use, then the routine initiates in block 174 a set-up process for the application, and then terminates as indicated in block 179. The set-up process may involve loading the application into fast access memory such as, for example, random access memory (RAM), and creating links between the service enhancement application and the requesting parent applications. These links are essentially handles that can be used for one application to communicate with the other via the SAM and the operating system.

A parent application may be, for example, a VOD application 44 (FIG. 2) that provides VOD services. Child applications that correspond to VOD application 44 may include, for example, service enhancements applications 45 that provide respective enhancements accessible via options 136-138 (FIG. 13) discussed above. In one embodiment, among others, a child application is only downloaded by a DHCT 20 if a corresponding parent application is already stored at the DHCT 20.

If in block 172 the routine determines that the application corresponding to the requested service enhancement application is not available at the DHCT 20, then the routine initiates in step 176 the downloading of the application. After the application is downloaded, the routine initiates in block 174 a set-up process for the application, and then terminates as indicated in block 179.

FIG. 18 is a flow chart depicting a service enhancement implementation routine 180 that is an alternative embodiment to the service enhancement implementation routine 170 illustrated in FIG. 6. Routine 180 is initiated in step 181 after a user requests a service enhancement. A service enhancement may be requested, for example, via the user interface screens depicted in FIGS. 12, 14, and 16. After the routine 180 is initiated, it determines in block 182 if the user is authorized to use the parent application corresponding to the requested service enhancement. As indicated above, a parent application is an application that provides a service that can be enhanced via a child application.

A user may be authorized to use a parent application if, for example, the user has subscribed to receive a service provided by the parent application. If the user is not authorized to use the parent application, then the user is offered the option of subscribing to use the parent application, as indicated in step 183. As a non-limiting example, if a user who is not authorized to receive VOD services requests a service enhancement enabling the user to view VOD previews, then the user may be presented with a barker that states “Would you like to subscribe to Video-On-Demand?” The user may then provide user input accepting or declining the offer. The routine 180 then determines in step 184 if the offer is accepted. If the offer is rejected, then the routine 180 terminates as indicated in step 185.

If the user is authorized to use the parent application or if the user accepts an offer to subscribe to an enhancement service provided by the parent application, then the routine 180 determines in step 187 if the parent application is available at the DHCT 20 (FIG. 1). If the parent application is not available at the DHCT 20, then the routine 180 initiates the downloading and set-up of the parent application. The routine 180 then determines in step 189 if the child application for providing the requested service enhancement is available at the DHCT 20. If the child application is available, then the routine 180 initiates in step 191 the set-up of the child application and terminates in step 193. However, if the child application is not available, then the routine 180 initiates in step 192 the downloading and set-up of the child application, and then terminates in step 193.

The user may be charged for a service enhancement or for a group of service enhancements in one or more ways. For example, the user may be charged based on a subscription period, usage time, frequency of use, and/or an availability period. A user may also be charged for a certain service enhancement in more than one way. As a non-limiting example, among others, a user may be charged based on both usage time and frequency of use.

It should be emphasized that the above-described embodiments of the present invention, particularly any “preferred embodiments”, are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention and protected by the following claims.

What is claimed:

1. A method, comprising:
providing a system operator with one or more video-on-demand (VOD) service enhancement configuration screens, the screens comprising plural selectable options corresponding to respective service enhancements to be implemented in association with a VOD service, the screens further comprising plural fields, each field corresponding to a charge for each of the service enhancements;
receiving input by the system operator corresponding to selection of one or more of the options and entry of the corresponding charge; and
communicating the selected options and the corresponding charge to a client premise over a network for display to a user.

2. The method of claim 1, where the options correspond to configuration of an audio language.

3. The method of claim 1, where the options correspond to configuration of trick mode functionality.

4. The method of claim 1, where the options correspond to configuration of a rental extension.

5. The method of claim 1, where the options correspond to configuration of recording of a VOD presentation.

6. The method of claim 1, where the options correspond to configuration of enhanced resolution of video images corresponding to a VOD presentation.

7. The method of claim 1, where the options correspond to configuration of pop-up comments.

8. The method of claim 1, where the options correspond to configuration of bookmarking functionality.

9. The method of claim 1, where the options correspond to configuration of multiple levels of video quality, audio quality, or a combination of both.

10. The method of claim 1, wherein the options and fields for pricing are provided in separate screens.

11. The method of claim 1, wherein the options and fields for pricing are provided in the same screen.

12. The method of claim 1, further comprising providing visual feedback in response to the selection input by the system operator.

13. A system, comprising:
a server configured to:
provide a system operator with a video-on-demand (VOD) service enhancement configuration screen, the screen comprising plural selectable options corresponding to respective service enhancements to be implemented in association with a VOD service, the screen further comprising plural fields, each field corresponding to a charge for each of the service enhancements;
receive input by the system operator corresponding to selection of one or more of the options and entry of the corresponding charge; and
communicate the selected options and the corresponding charge to a client premise over a network for display to a user.

14. The system of claim 13, where the options correspond to one or more of a configuration of an audio language, trick mode functionality, rental extension, recording of a VOD presentation, enhanced resolution of video images corresponding to the VOD presentation, pop-up comments, bookmarking functionality.

15. The system of claim 13, where the options correspond to one or more of a configuration of multiple levels of video quality, audio quality, or a combination of both.

16. The system of claim 13, wherein the options and fields for pricing are provided in separate screens.

17. The system of claim 13, wherein the options and fields for pricing are provided in the same screen.

18. The system of claim 13, further comprising providing visual feedback of a selection in response to the selection input by the system operator.
